(19) United States
(12) Patent Application Publication
(10) Pub. No.: US 2018/0054876 A1
(43) Pub. Date: Feb. 22, 2018

(54) OUT OF PLANE SENSOR OR EMITTER FOR COMMISSIONING LIGHTING DEVICES

(71) Applicant: ABL IP Holding LLC, Conyers, GA (US)

(72) Inventors: Sean P. White, Reston, VA (US); Daniel M. Megginson, Fairfax, VA (US); Jenish S. Kastee, South Riding, VA (US); Januk Aggarwal, Tysons Corner, VA (US); David P. Ramer, Reston, VA (US)

(21) Appl. No.: 15/240,134

(22) Filed: Aug. 18, 2016

(51) Int. Cl. H05B 37/02; H05B 33/08

(52) U.S. Cl. CPC H05B 37/0272; H05B 33/0842; H05B 37/0218; H05B 37/0227

(57) ABSTRACT

Determining respective locations of lighting devices in a service area includes a sensing device that receives light signals emitted by a number of lighting devices that are configured in a common plane. The sensing device is located outside the common plane, e.g. below the plane of light outputs of fixture mounted in or below a ceiling. Respective distances between each lighting device and the sensing device are calculated based on the received light signals. The locations of the plurality of lighting devices relative to the sensing device are calculated based on the calculated distances using trilateration, triangulation or parallax. In other systems, each lighting device includes a sensing device and the light signals are emitted by a pendant or wall-mounted sensor located outside the common plane. In another system, the locations are determined by sensing devices in the lighting devices based on light reflected from objects in the service area.

### TECHNICAL FIELD

The present subject matter relates to techniques and equipment to automatically commission lighting devices using data collected from out of the plane of the lighting devices.

### BACKGROUND

Traditional lighting devices have tended to be relatively dumb, in that they can be turned ON and OFF, and in some cases may be dimmed, usually in response to user activation of a relatively simple input device. Lighting devices have also been controlled in response to ambient light detectors that turn on a light only when ambient light is at or below a threshold (e.g. as the sun goes down) and in response to occupancy sensors (e.g. to turn on light when a room is occupied and to turn the light off when the room is no longer occupied for some period). Often traditional lighting devices are controlled individually or as relatively small groups at separate locations.

With the advent of modern electronics has come advancements, including advances in the types of light sources as well as advancements in networking and control capabilities of the lighting devices. For example, solid state sources are now becoming a commercially viable alternative to traditional light sources such as incandescent and fluorescent lamps. By nature, solid state light sources such as light emitting diodes (LEDs) are easily controlled by electronic logic circuits or processors. Electronic controls have also been developed for other types of light sources. As increased processing capacity finds its way into the lighting devices, it becomes relatively, easy to incorporate associated communications capabilities, e.g. to allow lighting devices to communicate with system control elements and/or with each other. In this way, advanced electronics in the lighting devices as well as the associated control elements have facilitated more sophisticated lighting control algorithms as well as increased networking of lighting devices.

Visible light communication (VLC) is one application of controllable lighting devices. VLC transmits information in indoor or outdoor locations, for example, from an artificial light source to a mobile device. The example VLC transmission may carry broadband user data, if the mobile device has an optical sensor or detector capable of receiving the high speed modulated light carrying the broadband data. In other examples, the light is modulated at a rate and in a manner detectable by a typical imaging device (e.g. a rolling shutter camera). This later type of VLC communication, for example, supports an estimation of position of the mobile device and/or provides some information about the location of the mobile device. These VLC communication technologies have involved modulation of artificially generated light, for example, by controlling the power applied to the artificial light source(s) within a lighting device to modulate the output of the artificial light source(s) and thus the light output from the device.

Deployment of substantial numbers of lighting devices with associated controllers and/or sensors and networking thereof presents increasing challenges for set-up and management of the system elements and network communication elements of the lighting system. In at least some applications, system commissioning may involve accurate determination of locations of installed lighting devices such as luminaires.

For a VLC location service, for example, it is desirable for the system to know the location of the luminaires, so that each luminaire can provide its location in the VLC signal or so that a mobile device or the like can look up an accurate luminaire location. The location of the mobile device can then be determined based on luminaire location data obtained by the mobile device. The location of each luminaire in a venue is determined as a part of the commissioning operation that is typically performed soon after the luminaire is installed. Depending on the number of luminaires and the size and configuration of the venue, the commissioning operation may be time consuming.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1A is a block diagram that shows a number of elements of a VLC system that uses out-of-plane data to automatically commission multiple lighting devices in a venue.

FIG. 1B is a bottom-plan view of the ceiling of a service area showing an example of a layout of lighting devices.

FIG. 1C is a block diagram showing the layout of an example lighting device.

FIGS. 2A and 2B are block diagrams of example pendant devices that may be used in the system shown in FIG. 1A.

FIG. 3 is a simplified functional block diagram of a personal computer or other user terminal device, which may be used as the remote access terminal, in a system like that of FIG. 1A.

FIG. 4 is a simplified functional block diagram of a computer configured as a host or server, for example, to function as the server in a system like that of the example of FIG. 1A.

FIG. 5 is a block diagram of an example system in which the pendant includes a sensing device.

FIG. 6 is a block diagram of an example system in which the pendant includes an emitter.

FIGS. 7A, 7B and 7C are block diagrams of a system that uses out-of-plane data reflected from objects in the venue.

FIGS. 8, 9 and 10 are flow-chart diagrams that illustrate the operation of the example systems shown in FIGS. 5, 6 and 7A-7C, respectively.

### DETAILED DESCRIPTION

The technology examples disclosed herein provide devices, programming and methodologies for improved commissioning of luminaires. As used herein, the terms “luminaires” and “lighting devices,” are synonymous. Examples of luminaires or lighting devices include various light fixtures or the like for indoor or outdoor residential or commercial applications. Luminaires or lighting devices for artificial lighting applications may use integral light sources or detectably connected lamps (often colloquially referred to as light “bulbs”). In addition, a lighting device may be a daylighting device such as a skylight, window or prismatic tubular skylight.

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

Lighting devices are commissioned after installation. In the examples, commissioning involves gathering information about the capabilities and location of the lighting devices. There are a multitude of ways information can be gathered to automatically determine the locations of lighting devices in a venue. One implementation involves installing a system with a retractable pendant, either in a given lighting device or in the vicinity of one or more devices. This pendant may be used to find distances from a given set point to each lighting device. Whether the hanging pendant is receiving information from the lighting device or emitting, the goal is to gather location information in relation to the pendant location. While commissioning information may be obtained using a hanging pendant, it is contemplated that other out-of-plane devices may be used. For example, commissioning information may also be obtained using a wall-mounted user interface device (e.g. a wall switch), a device on or that extends up from the floor, or a drone-like device that hovers above the floor and below the plane of the lighting devices or other device configured to sense light levels out of the plane of the lighting devices.

In an implementation for fixtures mounted in or hanging from a ceiling, the fixtures emit a line-of-sight light signal (including visible lighting (VL) or infrared (IR)) that may be sensed by the pendant because it is below the plane of the lighting devices. Daylighting devices may also be configured to emit a coded line-of-sight signal. The pendant may have a sensing device such as a camera or photo-sensor. In this example, the pendant, in communication with the network, causes specific lighting devices to emit their respective light signals at given times and use the received light signal to perform a distance calculation. Alternatively, if each device emits a respective visible light (VL), IR or other light based code word, all the lighting devices can emit at once assuming the pendant has a proper view of the lighting devices and the ability to concurrently decode multiple light signals.

As used herein, the common plane of the lighting devices represents an approximate plane formed by positions of the light-emitting elements of the lighting devices. In the ceiling example, the plane would correspond to vertical positions of the light-emitting elements/outputs of the fixtures at or below the ceiling of a service area, such as a room in a building. The common plane is not strictly a flat plane as fixture positions may vary by several centimeters from lighting device to lighting device. A lighting device in the common plane, however, typically cannot directly sense normal illumination light output from another lighting device in the plane.

Although many of the described examples sense light signals below the lighting devices, it is contemplated that lighting signals may also be sensed from above the devices. For example, in a service area having a number of floor lamps or table lamps that define the common plane, the sensor may sense light above the common plane. It is also contemplated that the sensor may be configured to sense light signals at or above the ceiling at a location where light emitted by the lighting devices is visible to the sensor. The techniques described herein may be used to sense light signals away from the common plane, either above or below the plane.

In another implementation, a VL/IR sensing device may be added to the lighting devices and the pendant device may be configured to emit a given light signal. A processor on the network may then cause each lighting device to report back time-of-flight (TOF) data. The TOF data can then be processed to determine respective distances from the pendant to the lighting devices. The light signals may include an embedded code or be transmitted at a specific wavelength. Gathering the correct emitted code and/or wavelength, assures the pendant is focused on the correct fixture.

The description below provides several examples of out-of-plane sensing (away from the common plane of the lighting devices) of light signals either from or by the lighting devices to determine respective locations of the lighting devices in the service area of the venue. As described above, the lighting devices may transmit this location data via VLC so that a mobile device in the venue may determine its location. Alternatively, the location of each lighting device may be stored in an accessible database so that the mobile device can obtain the lighting device location based on an identifier or other code received via VLC from the lighting device, to estimate mobile device location.

The various examples disclosed herein relate to a lighting system utilizing intelligent components and network communications, including techniques for commissioning various types of elements, of such a system for communications and/or logical relationships among such elements. Reference now is made in detail to the examples illustrated in the accompanying drawings and discussed below.

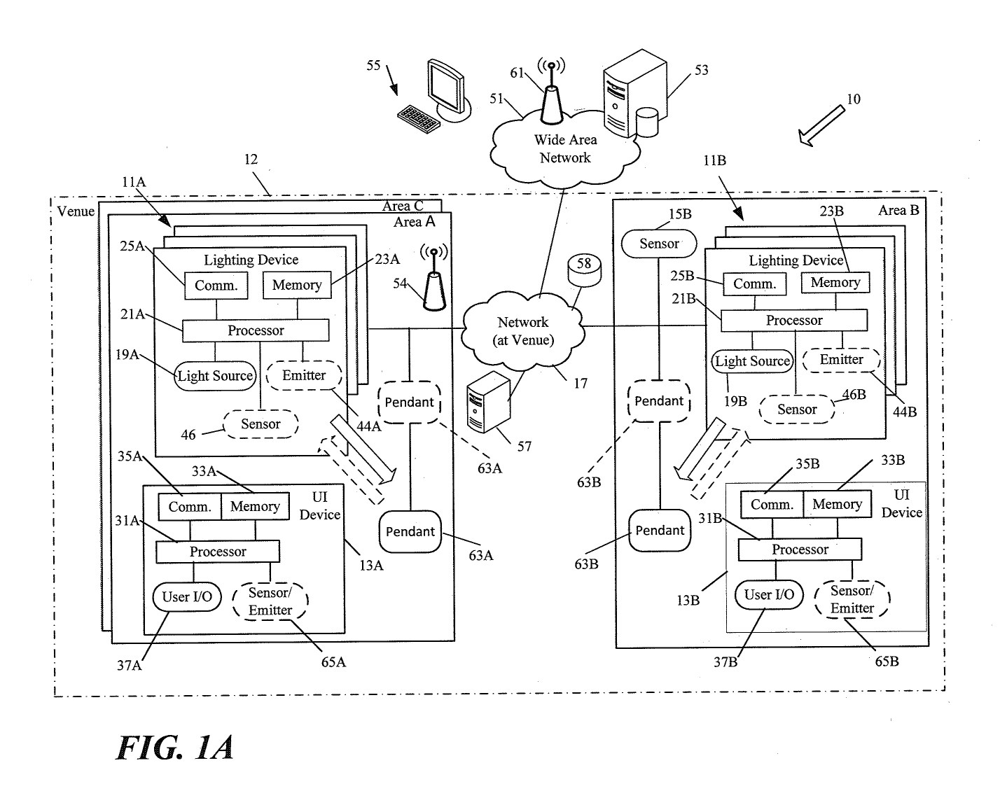

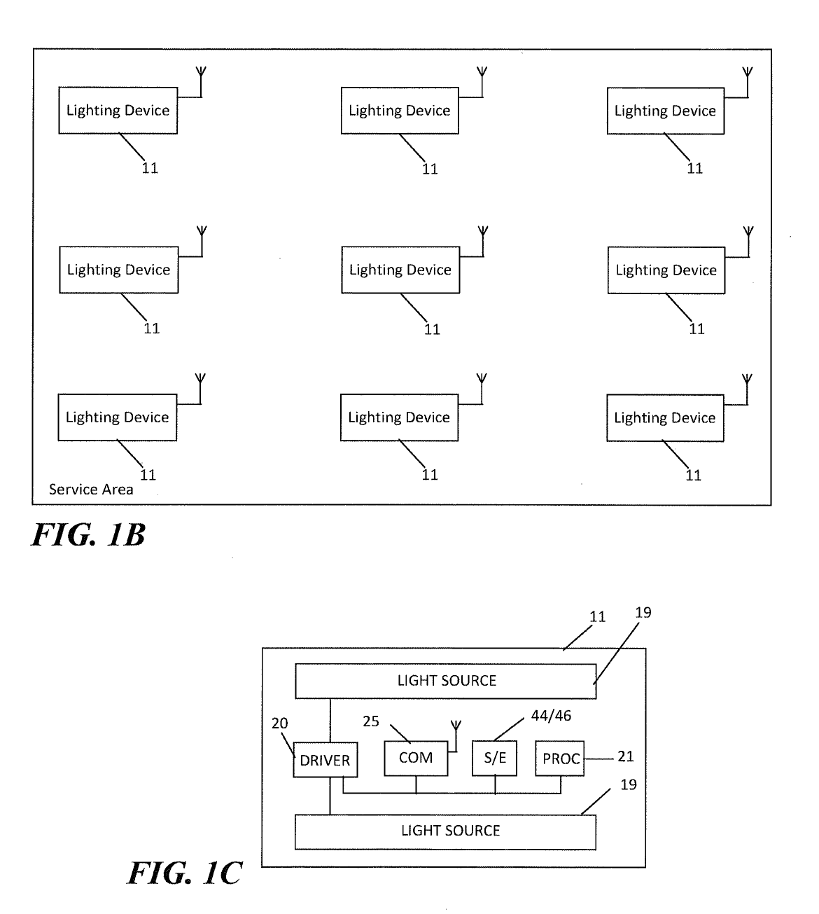

FIG. 1A is a high-level block diagram of a networked lighting system 10, many elements of which are installed at a venue 12. The venue 12 may be any location or locations serviced for lighting and other purposes by a networked intelligent lighting system of the type described herein. Most of the examples described below focus on building installations, for convenience, although the system may be readily adapted to outdoor lighting. Hence, the system 10 in the example provides lighting and possibly other services in a number of service areas in or associated with a building. In the example shown in FIG. 1A, the services are represented by areas A, B and C. In the examples described below these areas are rooms of a building. Examples of other types of service areas include a corridor, a building and an outdoor area associated with a building.

FIG. 1A also shows a network 17 in the venue having a controller 57 (e.g. a Central Overseer (CO)) and local storage 58. In addition, the venue 12 may be a part of a wider area network 51 that includes a server 53, a wireless communications module 61 and a control computer 55. Each area may include a wireless communications module 54 that may be used to communicate with the local network 17 or the wider area network 51.

The lighting system elements, in system 10 of FIG. 1A may include any number of lighting devices, such as fixtures and lamps, as well as lighting controllers, such as switches dimmers and smart control panels. The lighting controllers may be implemented by intelligent user interface devices 13, although intelligent user interface devices 13 in the system 10 may serve other purposes. The lighting system elements may also include one or more sensors used to control lighting functions, such as occupancy sensors, ambient light sensors and light or temperature feedback sensors that detect conditions of or produced by one or more of the lighting devices. The sensors may be implemented in intelligent standalone system elements, or the sensors may be incorporated in intelligent lighting devices, e.g. as an enhanced capability of a lighting device. A system like that shown in FIG. 1 may incorporate or at least provide communication capabilities or services for use by other devices, such as mobile devices (not shown) within the venue 12.

Hence, in the example, each room or other type of lighting service area illuminated by the system 10 includes a number of lighting devices 11 as well as other system elements such as one or more user interface devices 13 each configured as a lighting controller or the like. An example of the layout of lighting devices in a service area is shown in FIG. 1B, which is a bottom plan view of the ceiling of a service area. As shown, the service area includes nine lighting devices 11, each having the same orientation. The antennas on each of the example lighting devices indicate connection via a wireless implementation of network 17 (in addition or as an alternative to wired or optical fiber media/network). FIG. 1C shows the layout of an individual lighting device 11. As shown in FIG. 1C, each lighting device includes two light sources 19, a light driver 20, a communications interface 25 and a sensor/emitter 44/46. As described above, the lighting device may include a sensing device, such as an optical (e.g. visible light, IR and/or ultra-violet (UV)) camera, a photosensor (e.g. photodiode, photoresistor, phototransistor or photomultiplier device) an isotropic position sensitive detector (PSD), and/or an emitting device such as an visible light emitter, an IR emitter and/or a UV emitter. A PSD is an array of photosensitive elements, that outputs the position of spot of light on the sensor. The light driver 20 controls the light sources 19, which in this example are LED devices, to emit visible light for illumination as well as VLC signals. The driver 20, communications interface 25 and sensor/emitter 44/46 are all controlled by the processor 21. The communications interface 25 of the example lighting device 11 shown in FIG. 1C wirelessly connects the lighting device to the network 17, as indicated by the antenna.

As shown, the service area represented by room A in the example includes an appropriate number of first lighting devices 11A, for example, to provide a desired level of lighting for the intended use of the particular space in room A. The example equipment in room A also includes a user interface (UI) device 13A, which in this example, serves as a first lighting controller. In a similar fashion, the equipment in room or other service area B in the example includes an appropriate number of second lighting devices 11B, for example, to provide a desired level of lighting for the intended use of the particular space in area B. The equipment in service area B also includes a user interface (UI) device 13B, which in this example, serves as a second lighting controller. Examples of UI devices that may be used are discussed in more detail below.

Although some service areas may not include a sensor, the equipment in service area B includes a stand-alone sensor 15B. In the example, rooms A and B include respective retractable pendants 63A and 63B. Each of the pendants 63A and 63B is shown in two positions. The position indicated by the dashed lines is the retracted position in which the pendant 63 is in or above the common plane of the lighting devices 11. The position indicated by the solid lines is the extended position in which the pendant is below the common plane of the lighting devices 11. As described below, the pendant may include a sensing device such as a visible-light or infrared (IR) camera. Alternatively, the pendant 63A may include a visible-light or IR emitter and each of the lighting devices 11A and 11B may include a sensing device such as a visible-light or IR camera. The pendants 63 may be separate from the lighting devices or integral with one or more of the lighting devices in a room. A lighting device may, for example, include a light source on its bottom side and a camera or emitter on its top side. In this configuration, the lighting device may be lowered to serve as the pendant. In another configuration, the camera or emitter may be on the bottom side of the lighting device 11 and the device 11 may be flipped over when it is lowered.

In another alternative, the system may not use a pendant and the sensors and/or emitters may be implemented in the UI devices 13A and 13B as the sensor/emitter devices 65A and 65B. The sensing devices, whether implemented in the lighting devices 11, pendant 63 or UI device 13 may detect a condition that is relevant to lighting operations, such as location of the lighting device 11, pendant 63 or UE device 13; occupancy; ambient light level or color characteristics of light in an area or level; and/or color temperature of light emitted from one or more of the lighting devices serving the area.

The lighting devices 11A, the lighting controller 13A and the pendant 63A are located for lighting service of area A, that is to say, for controlled lighting within room A in the example. Similarly, the lighting devices 11B and lighting controller 13B are located for lighting service of area B, in this case, for controlled lighting room or other type of area B.

The equipment in room A, in this example, includes the lighting devices 11A, the lighting controller 13A and the pendant 63A that are coupled together for network communication with each other through data communication media generally represented by the cloud in the diagram to form a physical network 17. Similarly, the equipment in room B, in this example, the lighting devices 11B, the lighting controller 13B, sensor 15B and the pendant 63B, are coupled together for network communication with each other through data communication media generally represented by the cloud in the diagram to the physical network 17.

As described below, all of the devices that communicate with the network 17 may be synchronized to a common time base. In some implementations, the time base is used to determine a time-of-flight of an IR or visible light signal sent between the lighting devices and the pendant or other out-of-plane device.

Many installations include equipment for providing lighting and other services in a similar manner in other rooms and/or other types of services areas within or on a particular venue 12, such as in a building or on a campus.

The term “lighting device” as used herein is intended to encompass essentially any type of device that processes power to generate light, for example, for illumination of a space intended for use of or occupancy or observation, typically by a living organism that can take advantage of or be affected in some desired manner by the light emitted from the device. However, a lighting device may provide light for use by automated equipment, such as sensors/monitors, robots, etc. that may occupy or observe the illuminated space, instead of or in addition light for an organism. A lighting device, for example, may take the form of a table lamp, ceiling light fixture or other luminaire that incorporates a source, where the source by itself contains no intelligence or communication capability (e.g. LEDs or the like, or lamp (“regular light bulbs”) of any suitable type). Alternatively, a lighting device, fixture or luminaire may be relatively dumb but include a source device (e.g. a “light bulb”) that incorporates the intelligence and communication capabilities described herein. In most examples, the lighting device(s) illuminate a service area to a level useful for a human in or passing through the space, e.g. regular illumination of a room or corridor in a building or of an outdoor space such as a street, sidewalk, parking lot or performance venue. However, it is also possible that one or more lighting devices in or on a particular venue 12 served by a system 10 may have other lighting purposes, such as signage for an entrance or to indicate an exit. Of course, the lighting devices may be configured for still other purposes, e.g. to benefit occupants of the space (e.g. human or non-human organisms, robots, cyborgs, etc.) or to repel or even impair other occupants (e.g. human or non-human organisms, robots, cyborgs, etc.). The actual source in each lighting device may be any type of light emitting unit.

In the examples, the intelligence and communications interface(s) and in some cases the sensing devices are shown as integrated with the other elements of the lighting device or attached to the fixture or other element that incorporates the light source. However, for some installations, the light source may be attached in such a way that there is some separation between the fixture or other element that incorporates the electronic components that provide the intelligence and communication capabilities and/or any associated sensing device.

The example of system 10 utilizes intelligent lighting devices 11. Hence, each lighting device has a light source 19, a processor 21, a memory 23 and a communication interface 25. As described below, each lighting device 11 may also include an one or more emitters 44 (e.g. IR, visible light or ultra-violet emission devices), separate from the light source 19 and/or one or more sensing devices 46 (e.g. cameras and/or photosensors operating in the IR, visible light and/or ultra-violet wavelength ranges). By way of an example, one of the lighting devices 11A is shown in expanded block diagram form, as represented by the dashed line box at 11A. The drawing also shows one of the lighting devices 11B in expanded block diagram form. As shown at 11B, each lighting device 11B includes a light source 19B, a processor 21B, a memory 23B, a communication interface 23B an optional emitter 44B and an optional sensor 46B. Room B also includes a sensor 15B. This sensor may include, for example, an optical or IR sensing device, such as a photodiode, a photomultiplier, an optical or IR camera. It may also or alternatively include a temperature sensor, a motion sensor, a smoke detector, a CO detector and/or a humidity sensor and/or other types of environmental sensors.

Where a device includes multiple emitters or sensors, it is contemplated that the emitters and/or sensors may be configured on the device to selectively cover respectively different angular regions (e.g. left, right, forward and backward), centered on the device to provide information on the relative orientations of the devices. Alternatively, the multiple emitters or sensors may be mounted on the same side and separated by a known distance to facilitate parallax computations, as described below. In addition, different emitters may have different functions. One emitter may provide the light to be sensed while another emitter provides identifying information. As described above, these emitters may operate in the same or different wavelength bands.

The example system also includes intelligent UI interfaces that control the operation of the lighting devices in the service area. The UI device 13A in room A includes a processor 31A, a memory 33A, a communications interface 35A, a user input/output (I/O) device 37A and an optional sensor/emitter 65A. The user I/O device may be a toggle switch, a touch screen or other device through which a user may input commands to control the lighting devices in the room or to determine their status. Similarly, the UI device 13B in room B includes a processor 31B, a memory 33B, a communications interface 35B, a user input/output (I/O) device 37B and an optional sensor/emitter 65B.

The optional sensor/emitter 65 may be used in place of or in addition to the pendant 63 to determine respective locations of each of the lighting devices in the service area. When the UI device includes a sensor 65, the sensor may be configured as an occupancy sensor that turns on the light when motion is detected in the room. Alternatively, the sensor may be a light sensor, such as a camera, allowing the UI device to perform all of the functions of the pendant 63. When the UI device includes an emitter 65, the emitter may be used to send a light signal and, consequently, it may be beneficial to know the location of the UI device. As described below, this location may be determined using the pendant 63 at the same time the locations of the lighting devices 11 are determined.

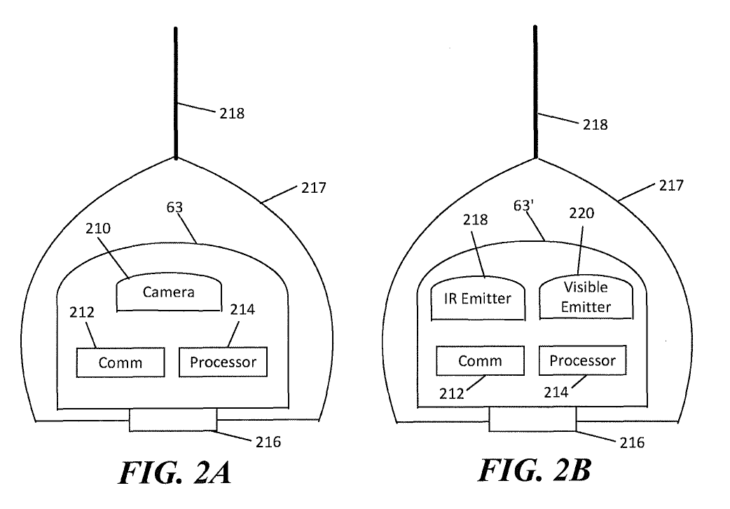

Example pendants are shown in FIGS. 2A and 2B. FIG. 2A shows a pendant 63 that includes a camera or other light sensor 210 that detects light signals emitted by the lighting devices in a particular service area. The pendant is controlled by a processor 214 which sends and receives data via a communications module 212. In this example, the pendant is supported by a cable 218 that connects to a mounting structure 216 via a harness 217. In this example, the harness 217 is formed from thin wires that do not block light from any of the lighting elements 11 in the service area. Although only two wires are shown, it is contemplated that the harness may include three or more wires each connecting to the mounting structure 216 to stabilize the pendant 63. Of course, other mounting or suspension arrangements may be used. The processor 214 may be configured to control the pendant 63 or 63′ or to control the pendant 63 or 63′ and all of the lighting devices 11, UI devices 13 and sensors 15. In this configuration, all of the calculations described below as being performed by the central overseer computer 57 may be performed by the processor 214 in the pendant 63 or 63′. Alternatively, this processing may be performed by the processor 21 (shown in FIG. 1A) of one of the lighting devices or the processor 31 (shown in FIG. 1A) of one of the UI devices.

FIG. 2B shows a pendant 63′ that includes an IR emitter, a visible-light emitter or both. The other components of the pendant 63′ are the same as in the pendant 63. This pendant relies on in the lighting devices having sensing devices (e.g. visible light or IR cameras or sensors) to detect either IR emissions, visible light emissions or both to implement the commissioning process.

As described above, the system elements in each service area include communications capabilities as well as intelligence. These communications capabilities may be implemented as interfaces to a wired (including fiber optic) or wireless network. The precise operations of such a system can be defined by provisioning and/or configuration data stored in and used by the various intelligent system elements. In the examples, provisioning data is data used to set-up or enable operation of a system element so as to communicate via at least a portion of one or more of the networks of the system 10 and though such networking to communicate with some or all of the other elements of the system. In addition to communication via the physical network, elements of the system 10 can be logically associated to form logical groups or logical sub-networks, for a variety of purposes. For example, it may not be feasible for a pendant to receive light signals from all of the lighting devices in a room. It may be desirable, therefore, to define multiple areas within a single room, each with its own pendant 63, stand-alone sensor 15 or UI device 13. In the examples, configuration data is data used to establish one or more such logical associations.

As used herein commissioning encompasses various functions to set-up elements of the system for operations. Examples of functions involved in commissioning include specifying respective physical locations for the elements and provisioning the elements for network communications, e.g. for physical communication with other elements via the applicable network media. Provisioning often entails at least some storage of data (sometimes referred to as provisioning data) for use in such communications within each system element. Some provisioning data also may be stored in an element implementing a routing or central network control function, e.g. to facilitate network-side aspects of the physical communications. Examples of functions involved in commissioning also include configuration of system elements to associate elements in one or more logical groupings of ‘sub-networks,’ to facilitate functional operations of the associated system elements. Configuration also typically entails storage of data (sometimes referred to as configuration data) in the elements being associated in a particular logical group or sub-network. For example, the data stored in an element may identify its location as well as one or more logical groupings to which the particular element belongs. Some configuration data also may be stored in an element designated to implement a central overseer (CO) type control function, or in other local storage 58 or an off-site server 53, e.g. for access by a mobile device during position estimation.

In the example of FIG. 1A, provisioning data is stored in the memories 23A of the lighting devices 11A, in the memory 33A of the UI device 13A and/or in the memory 58 of the CO 57 to enable physical communication among the lighting devices 11A, the UI device 13A and other elements in the network 17 and to enable physical communication among the lighting devices 11A, the UI device 13A and other devices in other service areas and venues via the wider area network 51. Configuration data stored in the memories 23A of the lighting devices 11A and the memory 33A of the lighting controller 13A may also logically associate the lighting devices 11A and the UI device 13A together to operate as an area lighting system for room A.

In a similar fashion, provisioning data also is stored in the memories 23B of the lighting devices 11B and the memory 33B of the lighting controller 13B to enable physical communication among the lighting devices 11B, the lighting controller 13B and other elements in the network 17B and to enable physical communication of the lighting devices 11B and the lighting controller 11B via the network 17 and/or the wider area network 51. Furthermore, configuration data stored in the memories 23B of the lighting devices 11B and the memory 33B of the lighting controller 13B logically associate the lighting devices 11B and the lighting controller 13B together to operate as an area lighting system for room B. As described below, the pendants 63A and 63B, when they are separate from the lighting devices may also include configuration data stored in local memories (not separately shown).

In addition, configuration data is stored in the memories of at least one of the first lighting devices 11A and the first lighting controller 13A and stored in the memories of at least one of the second lighting devices 11B and the second lighting controller 13B to logically associate the elements together to operate as a system for a predetermined function for both the first area A and the second area B. For example, such configuration data may be stored in the UI devices 13A and 13B to group the devices together, so as to coordinate a lighting status reporting function. Sensors 15 of a particular type. e.g. temperature, ambient light level and/or occupancy, also may be grouped together for a common reporting function or to provide a common influence with respect to lighting or some other operation or function associated with the building venue.

The provisioning and/or configuration data may be stored into the memories of the various system elements via a variety of procedures. For example, at least some provisioning and/or configuration data may be manually input by a technician with a terminal device, during system installation or as new elements are added to an existing installation. Examples discussed in more detail below rely on more automated commissioning techniques to acquire and store some or all such data that may be useful in setting up the elements to operate as a networked lighting system, including examples of determination and storage of lighting device location information.

At a high level, a lighting device 11A or 11B may be arranged so as to automatically exchange communications with one or more other lighting devices, to autonomously establish a network arrangement of the respective lighting device with the one or more other lighting devices. With such an arrangement for automatic commissioning, each lighting device automatically cooperates with the one or more other lighting devices to provide controlled lighting for a service area. For example, once commissioned, the lighting devices 11A cooperate to provide controlled illumination within the room A; and once commissioned, the lighting devices 11B cooperate to provide controlled illumination within the room or other type of service area B. Other elements, such as the UI devices 13, in this first example serving as the lighting controllers and any sensors 15 in the areas of lighting service similarly communicate with lighting devices. etc. to autonomously establish a network arrangement and to establish configuration(s) to enable such other elements to also cooperate in the controlled lighting for each respective service area.

The commissioning communications, to autonomously establish desired communications and cooperative logical relationships, involve one or more procedures to discover other lighting system elements and possibly the capabilities of such other elements and to establish logical relationships accordingly. In the examples described below, such discovery may relate to several somewhat different things. In one case, a lighting device or other system element discovers other elements with which the element is ‘networked.’ e.g. within a defined service area and/or providing a communication access to other networked facilities. Other cooperative relationships, however, may be established based on element discovery and associated configuration, for example, to discover other elements in the general vicinity, including some element(s) that may be outside the particular service area. Discovered elements ultimately may or may not be configured as part of the same logical network or group as the element that is conducting automatic discovery, for a particular system purpose. For example, this discovery may detect lighting devices 11A in room A as well as one or more devices outside the door of the room in an adjacent corridor type service area (not shown). For local control, the devices 11A are included in a group for room A, but the lighting device in the adjacent corridor would not. However, for emergency exit lighting, a device 11A near the door and one or more lighting devices in the corridor may be associated in a logical group or network to provide lighting in the event of a detected emergency such as a fire.

The lighting devices to be included in a group serving a particular service area or room may be identified using detection away from the common plane of illumination (out-of-plane), as described below. Briefly, this involves lowering the pendant or using other out-of-plane detection technique to determine which lighting devices may be sensed by the pendant or which lighting devices sense emissions from the pendant. These lighting devices are then grouped with the UI device to define the set of devices that service the service area or room. In addition to identity of the lighting devices, the discovery performed by the pendant or other out-of-plane device or technique determines the locations of the lighting devices in the service area. The obtained commissioning data for the lighting devices is then modified to include the location data so that the lighting devices can be used to implement a VLC location/navigation algorithm.

Discovery to form a sub-network or the like based on logical associations for a defined system function, purpose or service typically utilizes the network communications. As described below, however, discovery of elements for logical groupings and location determination may use other channels, such as a light channel based on transmission of a modulated light signal from one element (e.g. from a lighting device, a UI device or a pendant) and sensing the light signal by a sensing device in another system element (e.g. in another lighting device, sensor, UI device or pendant).

For convenience, the materials below first describe discovery by the pendant 63 of lighting devices 11 in a service area as an initial example, although similar procedures may apply in discovery of and by other types of elements of the system, such as lighting devices 11A and 11B, UI devices 13A and 13B and/or sensors such as 15B using other out-of-plane (above or below) sensing techniques. The described methods may also be used to discover lighting devices (not shown) in the service area that are out of the common plane or that form a different common plane such as table or floor lamps.

For example, the function to automatically exchange communications with one or more other lighting devices implemented by a respective lighting device may involve sending a light signal identifying the respective lighting device to the pendant. The pendant receives the signals and each such received signal identifies one of the other lighting devices. The pendant sends the received signals to the CO server 57 via the network 17. The server 57 compiles a list, table or the like in memory, to effectively store each received identification of another of the lighting devices in its memory as being associated with the pendant. In addition, as described below, the pendant may record the time of flight (TOF) for each light signal from the various lighting devices and other information such as how far below the common plane the pendant is suspended. The TOF value provides a measure of the distance between a lighting device and the pendant. As described below, other methods may be used to determine this distance such as parallax, perspective or perceived light intensity, using the inverse square law. The pendant may also record an estimate of the heading from which the light signal is received, also known as the angle of arrival. The heading or angle of arrival is the orientation of a three-dimensional vector between the pendant or sensor and the lighting device. The heading may be determined from the pixel position of an image of the lighting device on an imaging sensor or by using an angular light measuring device based on constructive occlusion and diffuse reflection such as the angular light sensor disclosed in U.S. Pat. No. 6,043,873 entitled “Position Tracking System,” which is incorporated herein by reference, The combination of the angle of arrival of the light signal from the lighting device and the distance between the lighting device and the pendant forms a vector. The locations of the lighting elements, relative to the pendant, may be determined, using the measured angles of arrival and/or distances, by trilateration, triangulation or parallax, as described below.

Although, in the example above, the server 57 received the provisioning and commissioning information for each of the lighting devices 11 and calculated the respective locations of the lighting devices, it is contemplated that these operations may be distributed such that, when the pendant is configured as an emitter, each lighting device can calculate its location relative to the pendant and provide this information as well as information about its capabilities to the server 57 via the network 17. Alternatively, the location calculations may be performed in the pendant 63 and sent to the server 57 via the network 17. It is contemplated that the processor 214 of the pendant 63 and/or the processor 21 in one or more of the lighting devices 11 may perform any or all of the described operations performed by the CO 57.

As described in more detail below, each lighting device 11 or other device may also send information identifying its capabilities to the pendant 63 (or other system elements) with which the respective device communicates. A respective lighting device or other device may also receive and store in its memory lighting device information identifying capabilities of each of the one or more others of the lighting devices in association with the stored identification of each of the one or more others of the lighting devices. Similar information may be obtained and stored in a memory with respect to other system elements, such as UI devices 13 and sensors 15.

In at least some examples, the lighting device or the like also detects signals from or communicates with other system elements in a manner that allows the element that is conducting its commissioning to detect system elements that are in its vicinity and/or to determine relative proximity of such other system elements. For example, the commissioning element may detect strength of some physically limited signal modulated with an identifier of another element, such as visible or infrared light, audio, etc.

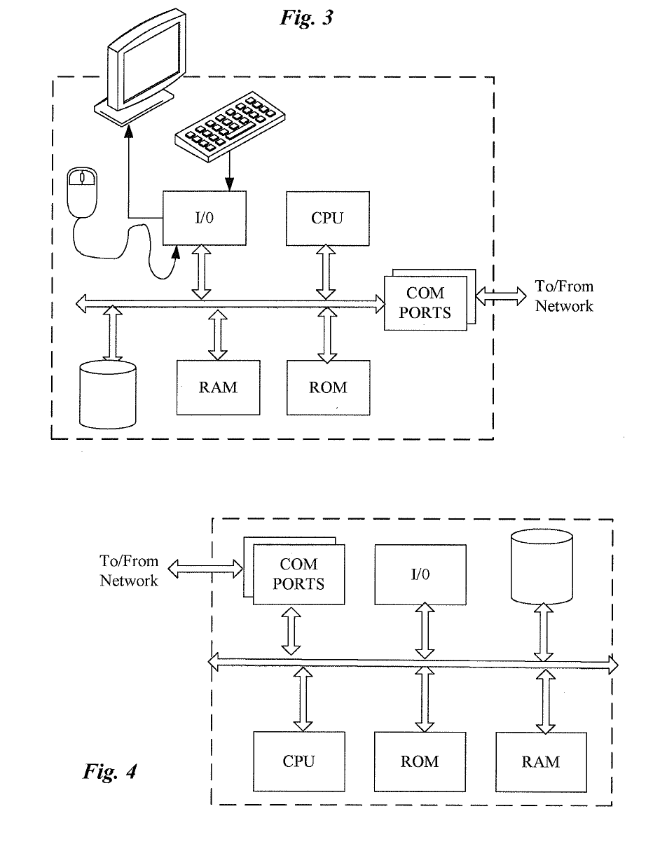

As described above, at least some functions of devices 53, 55 and 57 associated or in communication with the networked system encompassing the intelligent lighting devices 11 of FIG. 1A and pendant 63, may be implemented with general purpose computers or other general purpose user terminal devices, although special purpose devices may be used. FIGS. 3 and 4 provide functional block diagram illustrations of examples of general purpose hardware platforms.

FIG. 3 illustrates a computer type user terminal device which may be used as the terminal device 55 of FIG. 1A. The device shown in FIG. 3 may be a desktop or laptop type personal computer (PC) that includes a data communication interface, a central processing unit (CPU) in the form of one or more processors for executing instructions, main memory (such as a random access memory (RAM)) and one or more disc drives or other mass storage devices (not shown) for storing user data and the various executable programs.

FIG. 4 illustrates a server such as the server 53 or CO 57 that includes a data communication interface for packet data communication via the particular type of available network. The server also includes a CPU for executing program instructions. The server platform typically includes an internal communication bus, program storage and data storage for various data files to be processed and/or communicated by the server, although the server often receives programming and data via network communications. It is presumed that those skilled in the art are adequately familiar with the hardware elements, operating systems and programming languages of such servers. Of course, the server functions may be implemented in a distributed fashion on a number of similar platforms, to distribute the processing load. Also, a computer configured as a server with respect to one layer or function may be configured as a client of a server in a different layer and/or for a different function. It is believed that those skilled in the art are familiar with the structure, programming and general operation of the computer equipment shown in FIGS. 3 and 4 that, as a result the drawings should be self-explanatory.

Although FIGS. 3 and 4 in their present form show computers and user terminal devices, generally similar configurations also may be used within other elements of the lighting system. For example, one implementation of the control and communications elements of a lighting device 11 or a UI device 13 may utilize an architecture similar to that of one of the computers. As a more specific example, the personal computer type hardware in FIG. 3 (except for the keyboard, mouse and display) could serve as the control and communication elements of a lighting device 11, where the input/output interface I/O interfaces to an appropriate light driver and to any sensor(s) or other enhancement input or output device(s) included within the lighting device.

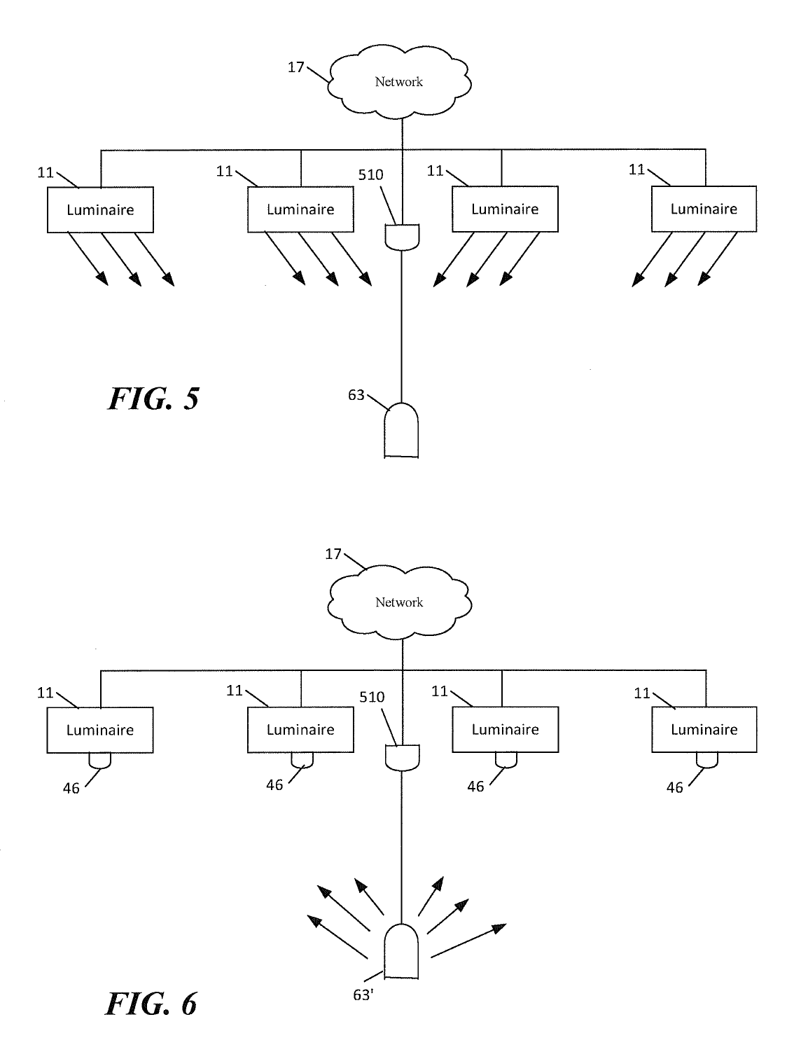

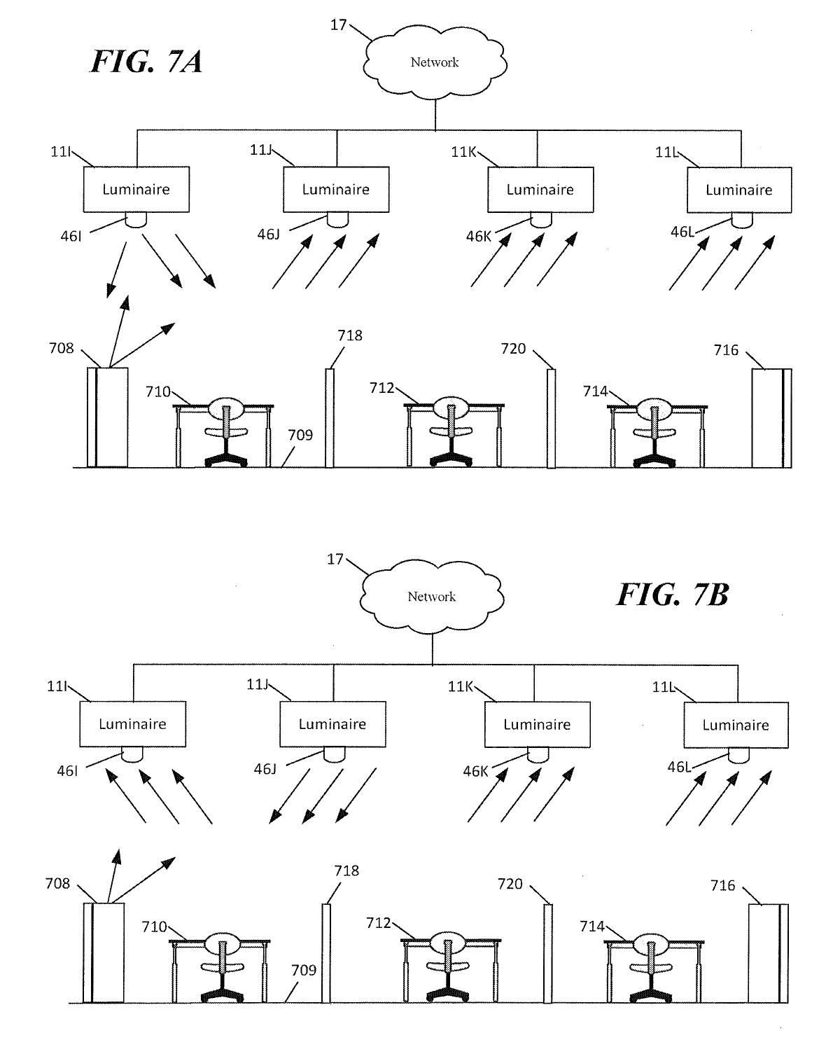

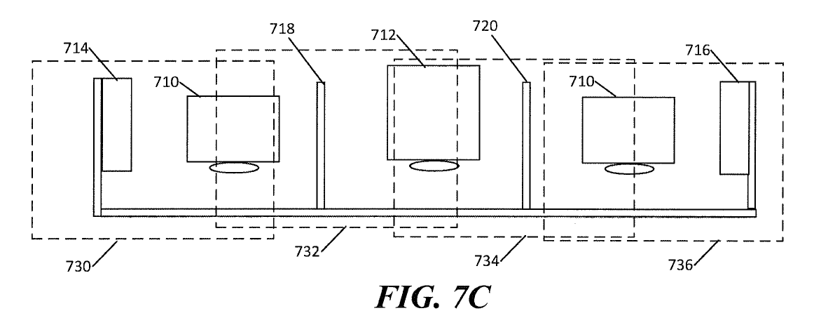

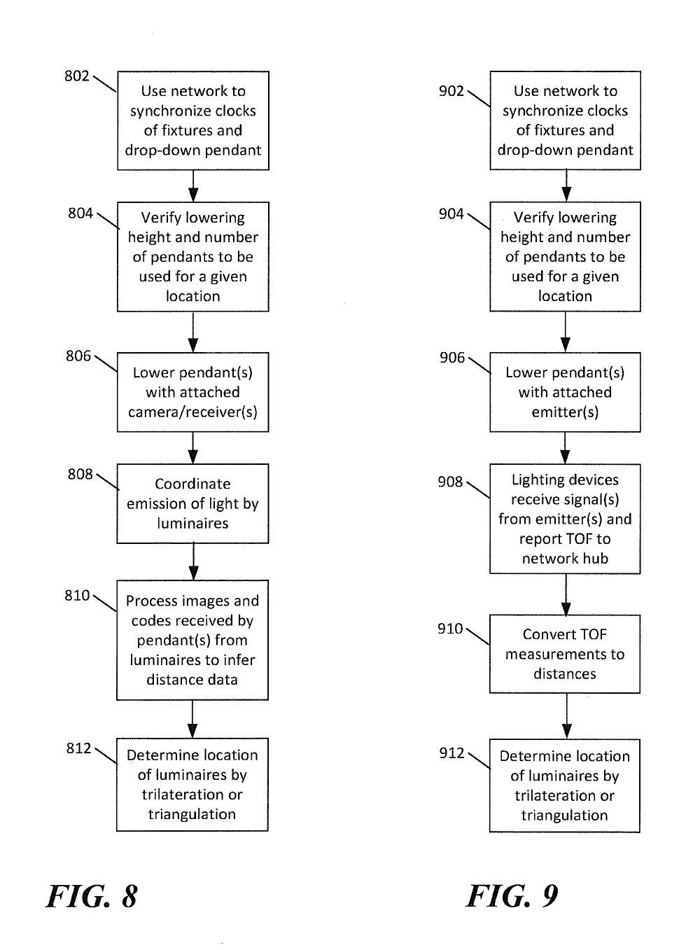

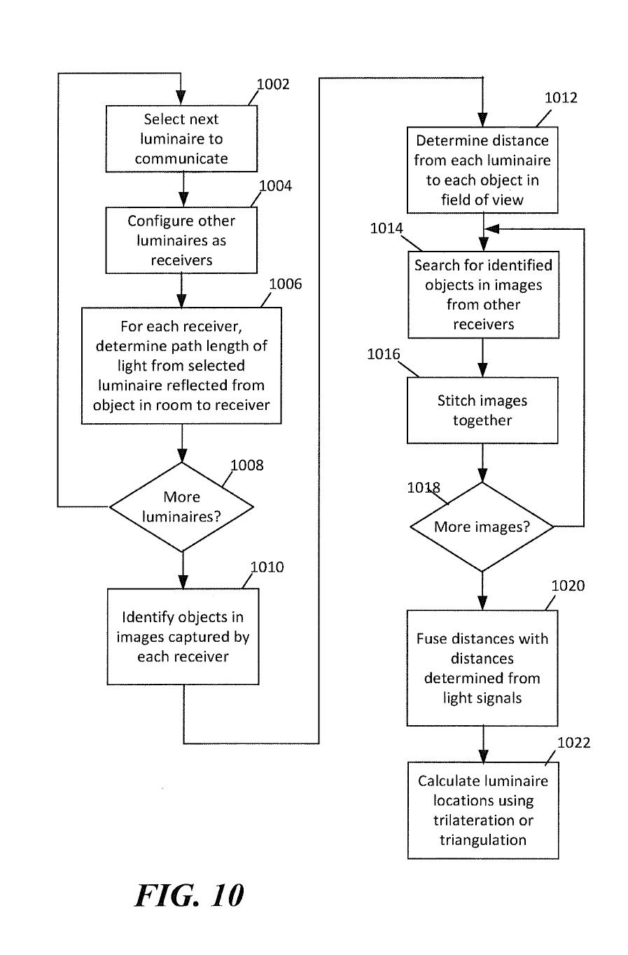

Specific examples of out-of-plane commissioning are described with reference to FIGS. 5-10. FIGS. 5 and 8 illustrate a first possible implementation, FIGS. 6 and 9 illustrate a second possible implementation and FIGS. 7A, 7B, 7C and 10 illustrate a third possible implementation. Each of these implementations may be performed using the central overseer 57 or by another processor, for example the processor in the pendant 63 one of the lighting devices 11 and/or one of the UI devices 13.

For each of these examples, it is assumed that the CO 57 has discovered all of the lighting devices 11 on the network 17. Each lighting device 11 has or is assigned a unique identifier. The CO 57, however, does not know the exact location of the lighting devices 11.

In the implementation shown in FIG. 5, a room includes four lighting devices 11 that emit VLC light signals. This implementation also includes a pendant 63, such as the pendant shown in FIG. 2A, that includes a sensing device such as a camera or other light sensor. The pendant 63 is connected to a device 510 that is tethered to the ceiling of the room and either allows or causes the pendant to be lowered or raised. The device 510 may include a motor coupled to the network 17 so that the pendant may be lowered on command from the central overseer (CO) 57. Alternatively, it may include a ratcheted pulley that allows a technician to manually lower the pendant by pulling on it.

Referring to FIG. 8, at block 802, the system 10 synchronizes the clock signals of all of the lighting devices 11 and the pendant 63. This synchronization is desirable to improve the accuracy of TOF measurements for the VLC signals emitted by the lighting devices 11 and received by the pendant 63. This operation synchronizes all of the clocks in all of the lighting devices 11, UI devices 13 and sensors 15 to the same time base so that time stamps issued are referenced to a common clock. Next, at block 804, the process determines a number of pendants to be lowered for a given venue and respective distances from the ceiling to which they should be lowered. As described above, a large venue or a venue having many rooms, hallways and service areas outside of a building may have several pendants to ensure coverage of all lighting devices 11 in the venue. Similarly, a venue having a high ceiling may allow the pendants 63 to be lowered by a greater distance and, thus, be able to image a larger number of lighting devices. In this implementation, the CO 57 knows which pendants 63 and which lighting devices 11 are in which service areas although it does not know the locations of the lighting elements 11 in each service area.

At block 806, the process causes the pendants 63 to be lowered. Next, at block 808, the system causes the lighting elements to emit light signals. In one implementation, the CO 57 may address each lighting device 11 individually and cause it to turn on at a respectively different time. Upon being turned on, the lighting device 11 may emit a coded signal, for example a VLC signal, that includes a time stamp indicating when the light signal was sent. At block 810, when this signal is received by the pendant 63, the TOF may be determined by subtracting the received time stamp from the current time value maintained by the pendant 63. The TOF calculation may also take into account processing delays in the lighting device 11 between the time the time stamp is generated and the light signal is transmitted and in the pendant 63 between the time the light signal is received and the time stamp is processed. This time delay for each device may be predetermined and stored in the device. The time delay for the lighting device may be transmitted with the time stamp. The calculated TOF may then be converted into a distance by multiplying the TOF by the speed of light, 3×10⁸ m/s.

Although this example describes using a time stamp to determine the distance between the pendant and the lighting devices, it is contemplated that distance may also be calculated by measuring the intensity of the light received from the lighting device and calculating the distance by applying the inverse square law. In this implementation, it is desirable to know the precise intensity of the light emitted by each lighting device and to have an unobstructed path from the lighting device to the pendant. As described above the distance between the pendant and the lighting devices may also be determined using parallax techniques or by using perspective techniques when the dimensions of the lighting devices are known or can be deduced and the relative orientations of the pendant and lighting devices are also known or can be deduced.

In this implementation, each lighting device 11 is activated in sequence by the CO 57. Alternatively, the CO may cause multiple lighting devices 11 to be activated concurrently. In this instance, the pendant would receive the time stamp and identification (ID) data from each of the fixtures. Using this data, the pendant 63 or the CO 57 can calculate the distance between the pendant and each light fixture.

In this example, the sensing device in the pendant 63 may be a camera having a view of at least a portion of the ceiling of the service area (e.g. room A). The camera may, for example, include a lens having a short focal length, such as a fish-eye lens, to produce a field of view that extends for 180 degrees in all directions. In addition to the pendant 63 detecting the time stamp and ID data from each fixture, the camera 210 of the pendant 63 captures an image of the ceiling with the fixture activated. From this image, the pendant 63 or CO 57 can determine the heading or angle of arrival of the light signal from the lighting device to the pendant. This heading may be determined, for example, from the pixel position of the received light signal on the image provided by the camera. Alternatively, the heading or angle of arrival of the light signal may be determined using an angular light measuring device based on constructive occlusion and diffuse reflection, as described above.

At block 812, the pendant 63 or CO 57 uses the respective distances to each of the lighting devices 11, the distance of the pendant below the common plane of the lighting devices 11 and the heading or angle of arrival of the light signal from each lighting device to determine a location of each of the lighting devices 11, in the service area, relative to the pendant. This location may be determined using trilateration, triangulation or parallax based on the respective distances and/or angles of arrival of the light signals from the lighting devices.

Triangulation may be accomplished using a side-side-angle congruence technique. In particular, the system knows the angle of the pendant cable to the common plane of the lighting devices 11 (90 degrees), the distance between the pendant and the common plane of the lighting devices (e.g. the length of the cable below the lighting devices), the distance between the lighting device and pendant and the angle of arrival of the light signal from the lighting device to the pendant. This information is sufficient to calculate the location of the lighting device relative to the pendant. These locations may be converted to absolute locations by referencing them to a known absolute location of the pendant 63. Although this example uses the position of the pendant as the known location, it is contemplated that another item, for example, one of the lighting devices may have a known location. In this instance, the location of the pendant or other out-of-plane device may not be known.

In another alternative, the locations of the lighting devices may be known but the assignment of identifiers to the lighting devices may not be known. In this alternative, the system may be used to associate received identifiers with calculated locations while matching the calculated locations to the known locations in a database that associates the identifiers with the locations to assist the VLC navigation application.

Similarly, the system may determine the locations by trilateration. Trilateration is typically used to determine the location of a central object based on distances of three or more peripheral objects having known locations. In this instance, however, the pendant is the central object having the known location and the locations of the lighting devices are unknown. Trilateration may be implemented by setting up a system of equations in which the respective locations of several lighting devices are unknown and solving the system of equations.

The system may also determine the locations by parallax. In this implementation, two pendants each having a sensor or two sensors on a single pendant (e.g. a sensor and a further sensor) determine the heading or angle of arrival of light from the lighting device. The distance between the two sensors is known. As the angle of arrival to each of the sensors is also known, the system can determine the location of the luminaire relative to the two pendants/sensors by simple geometry using angle-side-angle congruency.

The location of the lighting device may also be determined by a single pendant or image sensor if the dimensions of the lighting device and the relative orientation of the lighting device and the image sensor are known or can be deduced. In this example implementation, the perceived width of the lighting device at the sensor may be determined by isolating image data corresponding to the lighting device and measuring a pixel distance across the image. Based on the size of the image sensor and the focal length of a lens system of a camera that includes the image sensor, the measured pixel distance may be translated into a measured width of the image of the lighting device, as perceived by the image sensor. The distance from the image sensor to the lighting device may be determined using perspective techniques.

As described above, although FIGS. 5 and 8 shown a pendant 63 separate from the lighting devices 11 and suspended from the ceiling, it is contemplated that the functions performed by the pendant 63 may be performed by the UI device 13 or by one of the lighting devices 11 having either a camera mounted on its upper surface that may be lowered to implement the functions performed by the pendant 63, described above. Alternatively, the lighting device may be lowered and flipped-over (rotated about a horizontal axis) so that images of the other lighting fixtures are captured by the camera (sensing device) 46 of the lowered lighting device.

The implementation shown in FIGS. 6 and 9 is similar to that shown in FIGS. 5 and 8 except that the pendant 63′ emits the light signal and images of the signal emitted by the pendant are captured by the sensing devices 46 in the respective lighting devices 11. Blocks 902 and 904 are identical to blocks 802 and 804 and are not separately described. At block 906, the pendant 63′ containing the emitters is lowered to a predetermined distance below the common plane of the lighting devices 11. At block 908, the sensing devices 46 of the lighting devices having a field of view that includes the pendant receive the emitted light signal. As in FIG. 8, the light signal emitted by the pendant 63′ includes a time stamp and the pendant 63′ and all of the lighting devices 11 are synchronized to the same time base. Thus, each lighting device, at block 908 calculates the TOF of the light signal from the 63′ to the lighting device, as described above. This TOF value is transmitted to the CO 57 with information identifying the lighting device.

At block 910, the CO 57 has received TOF values from each of the lighting devices 11 in the service area and calculates respective distances to each of the lighting devices from the pendant 63′ as described above. At block 912, the CO 57 determines the location of the lighting devices using triangulation, trilateration or parallax based on these distances or on vectors between the lighting devices and the pendant 63′, as described above with reference to FIG. 8. Although the pendant 63′ is shown as being a separate device in FIG. 6, it is contemplated that the functions performed by the pendant 63′ may be implemented in one of the lighting devices 11, having an emitter on its top surface or being configured to be flipped over so that an emitter on its bottom surface can emit light toward the remaining lighting devices in the service area. In either case, the lighting device having the emitters would be lowered to the predetermined distance below the common plane of the lighting devices before being controlled to emit visible light or IR signals.

FIGS. 7A, 7B, 7C and 10 show another example out-of-plane location technique. This technique, however, does not employ an emitter or sensor that is away from the plane of the lighting devices. Instead, the lighting devices emit light or IR signals and detect the light or IR signals as they are reflected from objects in the service area. This method first determines a path length of light from one lighting device to another lighting device using light reflected from the floor or from objects in the service area. Next, each lighting device identifies objects in its field of view and determines its distance to at least one of the identified objects. Images captured by each of the lighting devices are transmitted to the CO 57 which stitches the images together to form a scene, in a common coordinate system, of the service area as viewed from the lighting devices. The CO 57 combines the distances from each lighting device to each object with the distances traveled by the reflected light signal from each lighting device to the lighting devices that received the reflected light. The CO 57 then calculates the location of each lighting device relative to each other lighting device in the common coordinate system.

FIGS. 7A and 7B show four lighting devices, 11I, 11J, 11K and 11L. These devices include respective sensing devices 46I, 46J, 46K and 46L. In this example the sensor is a camera sensitive to visible light, IR or both. The light sources are connected to the CO 57 (shown in FIG. 1) via the network 17. In addition, the service area includes objects that are illuminated by the light sources. These objects include book cases 708 and 716, tables 710, 712 and 714 and partitions 718 and 720.

This location method begins at block 1002 in which the CO 57 selects a first (or next) lighting device, 11I, to send a light signal having a time stamp and, at block 1004, configures the other lighting devices in the service area to receive the light signal. In one implementation, the receiving lighting devices may not emit light for illumination when they are configured to receive the light signal. In another implementation, all lighting devices may be configured to illuminate the service area and the selected device may emit a visible or IR light signal containing identifying information and a time stamp.

In the example shown in FIG. 7A the lighting device 11I is configured to both transmit and receive the light signal and lighting devices 11I, 11J, 11K and 11L are configured to receive the light signal. At block 1006, the lighting devices 11J, 11K and 11L receive the light signal that was emitted by device 11I and pass this information on to the CO 57 which calculates the path-lengths (TOF times the speed of light) of the light signal from device 11I to the devices 11J, 11K and 11L. This path length, however, is not the direct distance between the lighting devices. Instead, it is the length of a path of light reflected from an object in the service area, in this case, the top of the bookcase 708, the top of the desk 710 or from the floor 709. In calculating the distance from the transmitting to the receiving lighting devices, each device captures one or more images of the service area. The image is captured by the lighting device as it transmits the light signal

As shown in FIGS. 7A and 7B, light may be reflected from objects in the service area and from the floor. This may result in the lighting devices 11J, 11K and 11L receiving multiple light signals, a condition known as multipath. Depending on the reflectivity of the object or the floor, the second or later signal may have a greater magnitude than the first signal. To compensate for multipath, the CO may process only the first received signal for each lighting device. This signal is presumably reflected from the tallest object in the service area, in this instance, the top of the bookcase 708.

As described above, in block 1006, the lighting device 11I both transmits and receives the light signal. Block 1006 also calculates the distance traveled by the light signal that is both emitted and received by lighting device 11I, in this case, the round-trip-time from the device 11I, to the bookcase 708 and back to the device 11I multiplied by the speed of light. Rather than using the time-stamped signal to determine this distance, it is contemplated that the lighting device 11I may determine the distance using interferometry, by detecting an interference pattern between the emitted light signal and the received light signal to determine the round-trip-time.

At block 1008, the process determines whether more lighting devices exist in the service area and, if so, branches to block 1002 to select the next device. This step is shown in FIG. 7B, where the lighting device 11J is selected. As described above, at block 1004, device 11J is configured to both transmit and receive a light signal while the other devices, 11I, 11J, 11K and 11L are configured to receive light signals. At block 1006, the CO 57 determines the path length for the signal from device 11J to devices 11I, 11J, 11K and 11L.

When there are no more lighting devices to select at step 1008, control passes to block 1010. At block 1010, the CO 57 processes images captured by each of the devices 11I through 11L. In particular, respective sequences of images captured when each device emitted the light signal. This image includes pixels representing multiple objects in the service area, for example, the desks 710, 712 and 714, one or both of the bookcases 708 and 716 and the partitions 718 and 720. In this implementation, the CO 57 knows the height of the common plane of the lighting devices and the height above the floor of each of the objects—708, 710, 712, 714, 716, 718 and 720—in the service area.

At block 1012, the process analyzes the images to determine the distance from each lighting device to each object in the field of view. As described above, this distance may be calculated using round-trip-time or interferometry. At block 1014, the CO 57 analyzes images captured by all of the lighting devices to identify objects that are in more than one image. At block 1016, the CO stitches the images together until, at block 1018, the images from all of the lighting devices in the service area have been processed. As shown in FIG. 7C, the cameras 46I, 46J, 46K and 46L of the respective lighting devices 11I, 11J, 11K and 11L capture the respective images 730, 732, 734 and 736. These images are stitched together, as shown, to produce a composite image.

An example system that processes multiple overlapping images and stitches them together to form a composite image having a common coordinate system is described in U.S. Pat. No. 5,649,032 to Burt et al. entitled “System for Automatically Aligning Images to Form a Mosaic Image,” which is incorporated herein by reference for its teaching on forming a mosaic image from a plurality of overlapping input images taken from different points of view. Briefly, this method performs a pyramid decomposition on each image 730, 732, 734 and 736 in the set of overlapping images to generate a set of Gaussian (spatially low-pass filtered) and Laplacian (spatially high-pass filtered) images and, using the lowest-level Gaussian images, roughly aligns the images. The method then determines a common coordinate system and warps images to the coordinate system, using an affine transformation, to form the composite mosaic image at that level. As each Gaussian image is aligned, its corresponding Laplacian image is subject to the same transformation and added back to the Gaussian image to form the next-level Gaussian image. These steps are repeated until the composite mosaic is complete, that is, when the highest-level Laplacian image has been added to the highest level Gaussian image.

Next, at step 1020, the CO fuses the distances determined by each one lighting device to objects in its field of view with distances determined for the light signals from other lighting devices reflected to the one lighting device by the objects in the field of view of the one lighting device. This calculation may employ trilateration using a system of equations, triangulation or parallax using the known distance between the common plane of the lighting devices 11 and the objects in the field of view along with the distance traveled by the reflected light signal and the known distance from the lighting device to each object in the field of view. As described above, the triangulation calculation reduces to one or more angle-side-side congruence calculations.

Once these distances have been calculated, the CO, at step 1022, determines the location of each lighting device 11 in the service area. These locations may, for example, define one lighting device, preferably located in a corner of the room, as a reference having coordinate (0,0) and define locations of the other devices in the same coordinate system relative to the reference location. The reference coordinate may be converted to an absolute location by mapping it to a known location in the service area (room). Alternatively, other indoor location means may be used to determine a correspondence between the reference location and an absolute location. The remaining lighting devices in the service area may then determine their absolute locations based on the reference location.

When the CO has determined the location of each of the lighting devices 11, it may send this information to the devices 11 so that each lighting device 11 may provide the location information in the VLC signals emitted by the lighting devices to implement an indoor location system.

As outlined above, aspects of the lighting related operations of the CO 57, the lighting devices, the UI devices 13 and/or the sensors 15 may reside in software programs stored in the memories, RAM, ROM or mass storage. Program aspects of the technology discussed above therefore may be thought of as “products” or “articles of manufacture” typically in the form of executable code and/or associated data (software or firmware) that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software or firmware programming. All or portions of the programming may at times be communicated through the Internet or various other telecommunication networks. Such communications, for example, may enable loading of the devices, navigational programming, and image processing, including object recognition and data management computer application software from one computer or processor into another, for example, from the central overseer 57 or host computer of a lighting system service provider into any of the lighting devices 11, UI devices 13 and/or sensors 15. Thus, another type of media that may bear the software/firmware program elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible, “storage” type media, terms such as computer or machine “readable medium” refer to any medium that participates in providing instructions to a processor for execution.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A method, comprising:
receiving at a sensing device, a plurality of light signals emitted by a respective plurality of lighting devices wherein the plurality of lighting devices are arranged such that light emitting elements of the plurality of lighting devices are in a common plane and the sensing device is located away from the common plane;
calculating, based on the received light signals, respective distances between the sensing device and the plurality of lighting devices; and
determining respective locations of each of the plurality of lighting devices relative to the sensing device based on the calculated distances.

2. The method of claim 1, further comprising:
synchronizing the sensing device to the plurality of lighting devices prior to receiving the light signal emitted by each lighting device;
wherein the calculating respective distances between the sensing device and the plurality of lighting devices includes extracting respective time stamps from the received light signals and subtracting the respective time stamps from a current time value to calculate respective time-of-flight (TOF) value for the light signals.

3. The method of claim 1, wherein the calculating respective distances between the sensing device and the plurality of lighting devices includes:
measuring respective intensities for the received light signals from the plurality of lighting devices; and
calculating the respective distances using the measured intensities by applying the inverse square law to the measured intensities based on respective known intensities at the lighting devices.

4. The method of claim 1 wherein the determining respective locations for each of the plurality of lighting devices includes applying the respective distances and a known location of the sensing device to a system of trilateration equations.

5. The method of claim 1 wherein the determining respective locations for each of the plurality of lighting devices includes determining respective headings for the light signals received from the lighting devices and calculating the respective locations using triangulation based on a known distance between the sensing device and the common plane and a known location of the sensing device.

6. The method of claim 1 wherein the determining respective locations for each of the plurality of lighting devices includes determining respective angles of arrival for the light signals received from the lighting devices by the sensing device and a further sensing device and calculating the respective locations using parallax based on the angles of arrival, a known distance between the sensing device and the further sensing device and a known location of at least one of the sensing device and the further sensing device.

7. A method, comprising:
receiving a light signal at respective sensing devices of a plurality lighting devices, wherein the plurality of lighting devices are arranged such that light emitting elements of the plurality of lighting devices are in a common plane and the light signal is received from an emitting device positioned away from the common plane;
calculating, based on the received light signals, respective distances between the plurality of lighting devices and the emitting device; and
determining respective locations of each of the plurality of lighting devices relative to the emitting device based on the calculated distances.

8. The method of claim 7, further comprising:
synchronizing the emitting device and the sensing devices in the plurality of lighting devices to a common time base prior to receiving the light signal emitted by the emitting device;
wherein the calculating respective distances between the emitting device and the sensing devices of the plurality of lighting devices includes extracting respective time stamps from the received light signals and subtracting the extracted time stamps from a current time value to calculate respective time-of-flight (TOF) values for the light signals.

9. The method of claim 7, wherein the calculating respective distances between the emitting device and the plurality of lighting devices includes:
measuring respective intensities for the received light signals; and
calculating the respective distances using the measured intensities by applying the inverse square law based on respective known intensities at the emitting devices.

10. The method of claim 7 wherein the determining respective locations for each of the plurality of lighting devices includes applying the respective distances and a known location of the emitting device to a system of trilateration equations.

11. The method of claim 7 wherein the determining respective locations for each of the plurality of lighting devices includes determining respective headings for the light signals received from the emitting device and calculating the respective locations using triangulation based on a known spacing between the emitting device and the common plane and a known location of the emitting device.

12. The method of claim 7 wherein the determining respective locations for each of the plurality of lighting devices includes determining, by the respective sensing devices, respective angles of arrival for the light signals received from the emitting device and from a further emitting device and calculating the respective locations using parallax based on the angles of arrival, a known distance between the emitting device and the further emitting device and a known location of at least one of the emitting device and the further emitting device.

13. A method, comprising:
capturing at a plurality of sensing devices in a plurality of lighting devices, respective images each image including a respective light signal emitted by each respective lighting device of the plurality of lighting devices, wherein the plurality of lighting devices are arranged in a service area such that light emitting elements of the plurality of lighting devices are in a common plane and the received light signals are reflected from objects in the service area;
calculating, based on the received light signals, respective distances traveled by the received light signals; and
calculating, based on the received light signals, distances between the lighting devices and ones of the objects in the service area;
stitching together the respective images captured by the plurality of sensing devices in the plurality of lighting devices to generate a composite image having a common coordinate system; and
determining respective locations of each of the plurality of lighting devices based on the calculated distances and the composite image.

14. The method of claim 13 further comprising:
synchronizing the sensing devices and the light sources in the plurality of lighting devices to a common time base prior to receiving the light signals;
wherein the calculating respective distances traveled by the light signals includes extracting respective time stamps from the received light signals and subtracting the extracted time stamps from a current time value to calculate respective time-of-flight (TOF) values for the light signals; and
wherein the calculating of the respective distances between the lighting devices and the ones of the objects in the service area includes, for each lighting device, extracting a time stamp from one of the received light signals that was emitted by the lighting device and reflected from one of the objects in the service area and subtracting the extracted time stamp from a current time to calculate a round-trip-time value for the light signal.

15. The method of claim 13, wherein the calculating of the respective distances between the lighting devices and the ones of the objects in the service area includes, for each lighting device, analyzing a received light signal that is a light signal emitted by the lighting device.

16. A system, comprising:
a plurality of lighting devices in a service area, the plurality lighting devices being arranged such that light emitting elements of the plurality of lighting devices are in a common plane;
a sensing device arranged in the service area in a location at a predetermined distance away from the common plane;
a processor coupled to the plurality of lighting devices and to the sensing device, the processor including instructions that cause the processor to:
synchronize the lighting devices and the sensing device to a common time base;
cause the lighting devices to emit light signals, each light signal including a time stamp;
receive from the sensing device, data representing respective light signals emitted by the plurality of lighting devices and received by the sensing device;
calculate, based on the received data, respective distances between the sensing device and the plurality of lighting devices including subtracting time stamp values retrieved from the light signals from a current time value to determine respective time of flight (TOF) values for the light signals; and
determine respective locations of each of the plurality of lighting devices relative to the sensing device based on the calculated distances.

17. The system of claim 16, wherein the sensing device is a component of a pendant, the pendant being configured to move from a first position proximate to the common plane to a second position at the predetermined distance away from the common plane.

18. The system of claim 16, wherein the sensing device is included in one of the plurality of lighting devices, the sensing device being mounted on a top surface of the lighting device and the lighting device being configured to be lowered the predetermined distance away from the common plane.

19. The system of claim 16, wherein the sensing device is included in one of the plurality of lighting devices, the sensing device being mounted on a bottom surface of the lighting device and the lighting device being configured to be lowered and rotated about a horizontal axis to a position in which the sensing device receives the light signals from other lighting devices of the plurality of lighting devices.

20. The system of claim 16, wherein the sensing device is mounted on a wall of the service area at the predetermined distance away from the common plane.

21. A system, comprising:
a plurality of lighting devices in a service area, the plurality lighting devices being arranged such that light emitting elements of the plurality of lighting devices are in a common plane, each lighting device including a sensing device;
an emitting device arranged in the service area in a location at a predetermined distance away from the common plane;
a processor coupled to the plurality of lighting devices and to the emitting device, the processor including instructions that cause the processor to:
synchronize the lighting devices and the emitting device to a common time base;
cause the emitting device to emit light signals, each light signal including a time stamp;
receive from the sensing devices, data representing respective light signals emitted by the emitting device and received by the plurality of lighting devices;
calculate, based on the received data, respective distances between the emitting device and the plurality of lighting devices including subtracting time stamp values retrieved from the light signals from a current time value to determine respective time of flight (TOF) values for the light signals; and
determine respective locations of each of the plurality of lighting devices relative to the emitting device based on the calculated distances.

22. The system of claim 21, wherein the emitting device is a component of a pendant, the pendant being configured to move from a first position proximate to the common plane to a second position at the predetermined distance away from the common plane.

23. The system of claim 21, wherein the emitting device is included in one of the plurality of lighting devices, the emitting device being mounted on a top surface of the lighting device and the lighting device being configured to be lowered the predetermined distance away from the common plane.

24. The system of claim 21, wherein the emitting device is included in one of the plurality of lighting devices, the emitting device being mounted on a bottom surface of the lighting device and the lighting device being configured to be lowered and rotated about a horizontal axis to a position in which the emitting device transmits the light signals to other lighting devices of the plurality of lighting devices.

25. The system of claim 21, wherein the emitting device is mounted on a wall of the service area at the predetermined distance away from the common plane.

26. A system, comprising:
a plurality of lighting devices in a service area each lighting device including a camera, the plurality lighting devices being arranged such that light emitting elements of the plurality of lighting devices are in a common plane, the cameras of the lighting devices being configured to capture images of objects in the service area below the common plane;
a processor coupled to the plurality of lighting devices, the processor including instructions that cause the processor to:
synchronize the lighting devices and the sensing device to a common time frame;
cause the lighting devices to emit light signals, each light signal including a time stamp;
receive from the cameras, data representing respective light signals emitted by the plurality of lighting devices and received by the cameras;
calculate, based on the received data, respective distances traveled by the received light signals;
calculate, based on the received light signals distances between the lighting devices between the lighting devices and ones of the objects in the service area;
stitch together the respective images captured by the plurality of cameras in the plurality of lighting devices to generate a composite image having a common coordinate system; and
determining respective locations of each of the plurality of lighting devices based on the calculated distances and the composite image.

27. The apparatus of claim 26 wherein the instructions further cause the processor to:
synchronize the cameras and the light sources in the plurality of lighting devices to a common time base prior to receiving the light signals;
wherein the instructions that cause the processor to calculate the respective distances traveled by the light signals include instructions that cause the processor to extract respective time stamps from the received light signals and subtract the extracted time stamps from a current time value to calculate respective time-of-flight (TOF) values for the light signals; and
wherein the instructions that cause the processor to calculate the respective distances between the lighting devices and the ones of the objects in the service area include instructions that cause the processor to, for each lighting device, extract a time stamp from one of the received light signals that was emitted by the lighting device and reflected from one of the objects in the service area and subtract the extracted time stamp from a current time to calculate a round-trip-time value for the light signal.
